(19) United States
(12) Patent Application Publication
(10) Pub. No.: US 2023/0024667 A1
(43) Pub. Date: Jan. 26, 2023

(54) ARGYRODITE SOLID ELECTROLYTES FOR SOLID-STATE BATTERIES AND METHODS OF MAKING THE SAME

(71) Applicant: GM GLOBAL TECHNOLOGY OPERATIONS LLC, Detroit, MI (US)

(72) Inventors: Zhe LI, Shanghai (CN); Yong LU, Shanghai (CN); Haijing LIU, Shanghai (CN); Meiyuan WU, Shanghai (CN)

(73) Assignee: GM GLOBAL TECHNOLOGY OPERATIONS LLC, Detroit, MI (US)

(21) Appl. No.: 17/707,524

(22) Filed: Mar. 29, 2022

(30) Foreign Application Priority Data
Jul. 15, 2021 (CN) 202110800597.8

(51) Int. Cl. H01M 10/0562; H01M 4/04

(52) U.S. Cl. CPC H01M 10/0562; H01M 4/0416; H01M 2300/008; H01M 2300/0091

(57) ABSTRACT

The present disclosure provides a method for making a solid-state argyrodite electrolyte represented by Li₆PS₅X (where X is selected from chloride, bromide, iodine, or a combination thereof) having an ionic conductivity greater than or equal to about 1.0×10⁻⁴ S/cm to less than or equal to about 10×10⁻³ S/cm at about 25° C. The method may include contacting a first suspension and a first solution to form a precursor, where the first suspension is a Li₃PS₄ suspension including an ester solvent and the first solution is a Li₂S and LiX (where X is selected from chloride, bromide, or iodine, or a combination thereof) solution including an alcohol solvent; and removing the ester solvent and the alcohol solvent from the precursor to form the solid-state argyrodite electrolyte.

### CROSS-REFERENCE TO RELATED APPLICATIONS

This application claims priority to Chinese Application No. 202110800597.8, filed Jul. 15, 2021. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery.

A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of a solid-state battery, a solid-state electrolyte layer may be disposed between solid-state electrodes to provide physical separation such that a distinct separator may not be required. In each instance, a solid-state argyrodite electrolyte may be used, for example argyrodite Li₆PS₅X, where X is selected from chloride (Cl), bromide (Br), iodine (I), or a combination thereof. This solid-state argyrodite electrolyte may also be located in the negative and/or positive electrodes. Solid-state argyrodite electrolytes are often prepared using ball-milling methods. Using such methods, however, it can be difficult to obtain high-phase-purity products with uniform stoichiometry and sizes. Such methods are also often time or energy consuming and have poor manufacturing scalability. Accordingly, it would be desirable to develop methods for making solid-state argyrodite electrolytes that improve manufacturing processes.

### SUMMARY

This section provides a general summary of the disclosure, and is not a comprehensive disclosure of its full scope or all of its features.

The present disclosure relates to solid-state batteries, and in particular, solid-state electrolytes, and methods of forming the same.

In various aspects, the present disclosure provides a method for making a solid-state argyrodite electrolyte. The method may include contacting a first suspension and a first solution to form a precursor, where the first suspension includes Li₃PS₄ and an ester solvent, and the first solution includes Li₂S, LiX (where X is selected from chloride (Cl), bromide (Br), iodine (I), or a combination thereof), and an alcohol solvent; and removing the ester solvent and the alcohol solvent from the precursor to form the solid-state argyrodite electrolyte, where the solid-state argyrodite electrolyte is represented by the formula Li₆PS₅X, where X is selected from chloride (Cl), bromide (Br), iodine (I), or any combination thereof and the solid-state argyrodite electrolyte has an ionic conductivity greater than or equal to about 1.0×10⁻⁴ S/cm to less than or equal to about 10×10⁻³ S/cm at about 25° C.

In one aspect, the ester solvent may be selected from the group consisting of: methyl formate, methyl acetate, methyl propionate, methyl butyrate, methyl pentanoate, ethyl formate, ethyl acetate, ethyl propionate, ethyl butyrate, ethyl pentanoate, ethyl hexanoate, ethyl heptanoate, ethyl octanoate, ethyl decanoate, propyl acetate, propyl propanoate, isopropyl acetate, isopropyl palmitate, butyl acetate, butyl butyrate, isobutyl acetate, amyl acetate, pentyl propanoate, pentyl butyrate, pentyl pentanoate, pentyl hexanoate, isoamyl acetate, sec-amyl acetate, and combinations thereof.

In one aspect, the alcohol solvent may be selected from the group consisting of: 1-butanol, 2-butanol, isobutanol, tert-butanol, 1-pentanol, 2-pentanol, 3-pentanol, isopentanol, neopentanol, cyclopentanol, hexanol, cyclohexanol, methylcyclohexanol, heptanol, nonanol, and combinations thereof.

In one aspect, contacting the first suspension and the first solution to form a precursor may include forming a mixture including the first suspension and the first solution and mixing and stirring the mixture.

In one aspect, the mixture may be mixed and stirred for a time greater than or equal to about 30 minutes to less than or equal to about 24 hours.

In one aspect, the precursor may have a 1:1:1 molar ratio of Li₃PS₄:Li₂S:LiX.

In one aspect, the method may further include preparing the first suspension. Preparing the first suspension may include contacting Li₂S and P₂S₅ in the ester solvent to form a mixture, and mixing and stirring the mixture for a time greater than or equal to about 8 hours to less than or equal to about 96 hours.

In one aspect, the mixture may have a molar ratio of the Li₂S and P₂S₅ greater than or equal to about 2.9 to less than or equal to about 3.1.

In one aspect, a total concentration of the Li₂S and the P₂S₅ in the mixture may be greater than or equal to about 0.5 wt. % to less than or equal to about 50 wt. %.

In one aspect, the method may further include preparing the first solution. Preparing the first solution may include contacting Li₂S and LiX in the alcohol solvent to form a mixture, and mixing and stirring the mixture for a time greater than or equal to about 0.1 hours to less than or equal to about 24 hours.

In one aspect, the mixture may have a molar ratio of the Li₂S and the LiX of greater than or equal to about 0.9 to less than or equal to about 1.1.

In one aspect, a total concentration of the Li₂S and the LiX in the mixture may be greater than or equal to about 0.1 wt. % to less than or equal to about 20 wt. %.

In one aspect, removing the ester solvent and the alcohol solvent from the precursor solution to form the solid-state argyrodite electrolyte may include heating the precursor to a temperature greater than or equal to about 80° C. to less than or equal to about 700° C. for a time greater than or equal to about 30 minutes to less than or equal to about 48 hours.

In one aspect, the solid-state argyrodite electrolyte may include a plurality of Li₆PS₅X particles having an average particle size greater than or equal to about 0.1 μm to less than or equal to about 100 μm.

In various aspects, the present disclosure provides a method for making an electrode including a solid-state argyrodite electrolyte. The method may include contacting a precursor liquid and a precursor electrode, where the precursor liquid comprises a 1:1:1 molar ratio of Li₃PS₄:Li₂S:LiX, where X is selected from chloride (Cl), bromide (Br), iodine (I), or any combination thereof suspended in a co-solvent system that comprises an ester solvent and an alcohol solvent; and removing the co-solvent system including the ester solvent and the alcohol solvent from the precursor liquid to form the electrode including the solid-state argyrodite electrolyte. The solid-state argyrodite electrolyte may be represented by the formula Li₆PS₅X, where X is selected from chloride (Cl), bromide (Br), iodine (I), or any combination thereof. The solid-state argyrodite electrolyte may have an ionic conductivity greater than or equal to about 1.0×10⁻⁴ S/cm to less than or equal to about 10×10⁻³ S/cm at about 25° C.

In one aspect, the method my further include preparing the precursor liquid. Preparing the precursor liquid may include contacting a first suspension and a first solution, where the first suspension includes Li₃PS₄ and an ester solvent and the first solution includes the Li₂S, the LiX, and the alcohol solvent.

In one aspect, contacting the first suspension and the first solution to form a precursor liquid may include forming a first mixture including the first suspension and the first solution and mixing and stirring the first mixture for a time greater than or equal to about 30 minutes to less than or equal to about 24 hours.

In one aspect, the method may further include preparing the first suspension. Preparing the first suspension may include contacting Li₂S and P₂S₅ in the ester solvent to form a second mixture, and mixing and stirring the second mixture for a time greater than or equal to about 8 hours to less than or equal to about 96 hours.

In one aspect, the method may further include preparing the first solution. Preparing the first solution may include contacting the Li₂S and the LiX in the alcohol solvent to form a third mixture, and mixing and stirring the third mixture for a time greater than or equal to about 0.1 hours to less than or equal to about 24 hours.

In one aspect, removing the ester solvent and the alcohol solvent from the precursor liquid may include heating the precursor liquid to a temperature of greater than or equal to about 80° C. to less than or equal to about 700° C. for a time of greater than or equal to about 30 minutes to less than or equal to about 48 hours.

In one aspect, the electrode may include a plurality of solid-state electroactive material particles and the solid-state argyrodite electrolyte may forms a continuous coating on the solid-state electroactive material particles.

In various aspects, the present disclosure provides a method for making an electrochemical cell including a solid-state argyrodite electrolyte. The method may include contacting a precursor liquid and at least a portion of a precursor cell, where the precursor liquid includes a 1:1:1 molar ratio of Li₃PS₄:Li₂S:LiX, where X is selected from chloride (Cl), bromide (Br), iodine (I), or any combination thereof suspended in a co-solvent system that includes an ester solvent and an alcohol solvent; and removing the co-solvent system including the ester solvent and the alcohol solvent from the precursor liquid to form the electrochemical cell including the solid-state argyrodite electrolyte. The solid-state argyrodite electrolyte may be represented by the formula Li₆PS₅X, where X is selected from chloride (Cl), bromide (Br), iodine (I), or any combination thereof. The solid-state argyrodite electrolyte may have an ionic conductivity greater than or equal to about 1.0×10⁻⁴ S/cm to less than or equal to about 10×10⁻³ S/cm at about 25° C.

In one aspect, the method may further include preparing the precursor liquid. Preparing the precursor liquid may include preparing a first suspension, wherein preparing the first suspension includes contacting Li₂S and P₂S₅ in the ester solvent to form a second mixture, and mixing and stirring the second mixture for a time greater than or equal to about 8 hours to less than or equal to about 96 hours; preparing the first solution, where preparing the first solution includes contacting the Li₂S and the LiX in the alcohol solvent to form a third mixture, and mixing and stirring the third mixture for a time greater than or equal to about 0.1 hours to less than or equal to about 24 hours; and contacting the first suspension and the first solution.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example solid-state battery;

FIG. 2 is an illustration of an example method for forming a solid-state argyrodite Li₆PS₅X (where X is selected from chloride (Cl), bromide (Br), iodine (I), or a combination thereof) electrolyte for use in a solid-state battery, such as illustrated in FIG. 1;

FIG. 3A is an illustration of an example method for forming an electrode, including a solid-state argyrodite Li₆PS₅X (where X is selected from chloride (Cl), bromide (Br), iodine (I), or a combination thereof) electrolyte, for use in a solid-state battery, such as illustrated in FIG. 1;

FIG. 3B is another illustration of the example method depicted in FIG. 3A;

FIG. 4A is an illustration of an example method for forming a solid-state battery, including a solid-state argyrodite Li₆PS₅X (where X is selected from chloride (Cl), bromide (Br), iodine (I), or a combination thereof) electrolyte, such as the example solid-state battery illustrated in FIG. 1;

FIG. 4B is another illustration of the example method depicted in FIG. 4A;

FIG. 4C is another illustration of the example method depicted in FIG. 4A; and

FIG. 4D is another illustration of the example method depicted in FIG. 4A.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another component, element, or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure relates to solid-state batteries, and in particular, solid-state electrolytes, and methods of forming the same. Solid-state batteries may include at least one solid component, for example, at least one solid electrode, but may also include semi-solid or gel, liquid, or gas components, in certain variations. Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

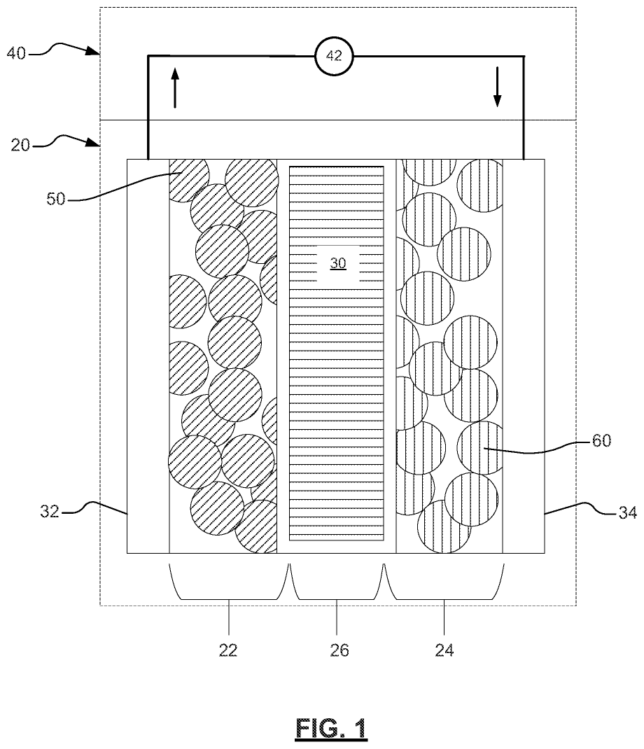

An exemplary schematic illustration of a solid-state electrochemical cell unit (also referred to as a “solid-state battery” and/or “battery”) 20 that cycles lithium ions is shown in FIG. 1. The battery 20 includes a negative electrode (i.e., anode) 22, a positive electrode (i.e., cathode) 24, and a separator 26 (e.g., a microporous polymeric separator) that occupies a space defined between the two or more electrodes. The separator 26 physically separates the negative electrode 22 from the positive electrode 24. The separator 26 between the negative electrode 22 and the positive electrode 24 can be at least partially filled, and in certain variations, substantially filled, with a solid-state electrolyte 30. If there are pores inside the negative electrode 22 and positive electrode 24, the pores may also be at least partially filled, and in certain variations, substantially filed, with the solid-state electrolyte 30, so as to form a continuous electrolyte network, which may be a continuous lithium-ion conduction network.

A negative electrode current collector 32 may be positioned at or near the negative electrode 22. A positive electrode current collector 34 may be positioned at or near the positive electrode 24. The negative electrode current collector 32 may be formed from stainless steel foil or any other appropriate electrically conductive material known to those of skill in the art. The positive electrode current collector 34 may be formed from aluminum or any other electrically conductive material known to those of skill in the art. The negative electrode current collector 32 and the positive electrode current collector 34 respectively collect and move free electrons to and from an external circuit 40 (as shown by the block arrows). For example, an interruptible external circuit 40 and a load device 42 may connect the negative electrode 22 (through the negative electrode current collector 32) and the positive electrode 24 (through the positive electrode current collector 34).

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the separator 26 towards the positive electrode 24. The electrons flow through the external circuit 40 and the lithium ions migrate across the separator 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back toward the negative electrode 22 through the external circuit 40, and the lithium ions, which move across the separator 26 back toward the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the separator 26.

In many configurations, each of the negative electrode current collector 32, the negative electrode 22, the separator 26, the positive electrode 24, and the positive electrode current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, although not illustrated, the negative electrode 22 comprises a mixture of the negative solid-state electroactive particles 50 and the solid-state electrolyte 30. For example, the negative electrode 22 may include greater than or equal to about 30 wt. % to less than or equal to about 98 wt. %, and in certain aspects, optionally greater than or equal to about 50 wt. % to less than or equal to about 95 wt. %, of the negative solid-state electroactive particles 50 and greater than or equal to about 0 wt. % to less than or equal to about 50 wt. %, and in certain aspects, optionally greater than or equal to about 5 wt. % to less than or equal to about 20 wt. %, of the solid-state electrolyte 30. The negative electrode 22 may have a thickness greater than or equal to about 10 μm to less than or equal to about 400 μm.

In certain variations, the negative solid-state electroactive particles 50 may be lithium-based, for example, the negative electrode 22 may be a carbonaceous anode and the negative solid-state electroactive particles 50 may comprise one or more negative electroactive materials, such as graphite, graphene, hard carbon, soft carbon, and carbon nanotubes (CNTs). In other variations, the negative solid-state electroactive particles 50 may be silicon-based comprising, for example, a silicon alloy and/or silicon-graphite mixture. In still other variations, the negative electrode 22 may include a lithium alloy or a lithium metal. In still further variations, the negative electrode 22 may comprise one or more negative electroactive materials, such as lithium titanium oxide (Li₄Ti₅O₁₂), metal oxides (e.g., TiO₂ and/or V₂O₅), metal sulfides (e.g., FeS), transition metals (e.g., tin (Sn)), and other lithium-accepting materials. Thus, the negative solid-state electroactive particles 50 may be selected from the group including, for example only, lithium, graphite, graphene, hard carbon, soft carbon, carbon nanotubes, silicon, silicon-containing alloys, tin-containing alloys, and any combination thereof.

In certain variations, the negative electrode 22 may further include one or more conductive additives and/or binder materials. For example, the negative solid-state electroactive particles 50 (and optionally the solid-state electrolyte 30) may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 (and optionally the solid-state electrolyte 30) may be optionally intermingled with binders, such as polyvinylidene difluoride (PVDF), poly(vinylidene fluoride-co-hexafluoropropylene PVdF-HFP), polytetrafluoroethylene (PTFE), sodium carboxymethyl cellulose (CMC), nitrile butadiene rubber (NBR), styrene ethylene styrene copolymer (SEBS), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers (e.g., nanofibers) and nanotubes, graphene (such as, graphene oxide), carbon black (such as, Super P), and the like. Examples of a conductive polymer may include polyaniline, polythiophene, polyacetylene, polypyrrole, and the like. In certain aspects, mixtures of the conductive additives and/or binder materials may be used.

The negative electrode 22 may include greater than or equal to about 30 wt. % to less than or equal to about 98 wt. % of the negative electroactive material; greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, although not illustrated, the positive electrode 24 comprises a mixture of the positive solid-state electroactive particles 60 and the solid-state electrolyte particles 30. For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60 and greater than or equal to about 0 wt. % to less than or equal to about 50 wt. %, and in certain aspects, optionally greater than or equal to about 5 wt. % to less than or equal to about 20 wt. %, of the solid-state electrolyte 30. The positive electrode 24 may have a thickness greater than or equal to about 10 μm to less than or equal to about 400 μm.

In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0<y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

In certain variations, the positive electrode 24 may further include one or more conductive additives and/or binder materials. For example, the positive solid-state electroactive particles 60 (and optionally the solid-state electrolyte 30) may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 (and optionally the solid-state electrolyte 30) may be optionally intermingled with binders such as polyvinylidene difluoride (PVDF), poly(vinylidene fluoride-co-hexafluoropropylene PVdF-HFP), polytetrafluoroethylene (PTFE), sodium carboxymethyl cellulose (CMC), nitrile butadiene rubber (NBR), styrene ethylene styrene copolymer (SEBS), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers (e.g., nanofibers) and nanotubes, graphene (such as, graphene oxide), carbon black (such as, Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may include greater than or equal to about 30 wt. % to less than or equal to about 98 wt. % of the positive electroactive material; greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

The separator 26 provides mechanical support and electrical separation—preventing physical contact—between the negative electrode 22 and the positive electrode 24. In certain variations, the porous separator 26 may be a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain variations, the separator 26 may be a high-temperature (e.g., greater than about 150° C.) stable separator that comprises polyimide (PI) nanofiber-based nonwovens, nano-sized Al₂O₃ and poly(lithium 4-styrenesulfonate)-coated polyethylene membranes, co-polyimide-coated polyethylene separators, polyetherimides (PEI) (bisphenol-aceton diphthalic anhydride (BPADA) and para-phenylenediamine) separators, expanded polytetrafluoroethylene reinforced polyvinylidenefluoride hexafluoropropylene separators, sandwich-structured polyvinylidene fluoride (PVdF)/poly(m-phenylene isophthalamide (PMIA)/polyvinylidene fluoride (PVdF) nanofibrous separators, and the like.

In each instance, the separator 26 may further include one or more of a ceramic coating layer and a heat-resistant material coating. For example, the ceramic coating layer and/or the heat-resistant material coating may be disposed on one or more sides of the separator 26. The material forming the ceramic layer may be selected from the group consisting of: alumina (Al₂O₃), silica (SiO₂), and combinations thereof. The heat-resistant material may be selected from, for example, NOMEX™ and/or ARAMID.

The positive electrode 24, the negative electrode 22, and the separator 26 may each include a sold-state electrolyte 30 inside their pores, capable of conducting lithium ions between the negative electrode 22 and the positive electrode 24. For example, the separator 26 may include greater than or equal to about 10 wt. % to less than or equal to about 80 wt. % of the solid-state electrolyte 30. In various aspects, the solid-state electrolyte 30 may be solid-state argyrodite electrolyte, for example argyrodite represented by the formula: Li₆PS₅X, where X is selected from chloride (Cl), bromide (Br), iodine (I), or a combination thereof. In certain variations, the solid-state argyrodite electrolyte represented by the formula Li₆PS₅X, where X is selected from chloride (Cl), bromide (Br), iodine (I), or a combination thereof, may be in the form of a plurality of particles that are disposed in pores of the separator 26 and/or the negative electrode 22 and/or positive electrode 24, so as to form a continuous electrolyte network, which may be a continuous lithium-ion conduction network. The solid-state electrolyte 30 may have an average thickness greater than or equal to about 0.01 μm to less than or equal to about 100 μm, and in certain aspects, optionally greater than or equal to about 0.1 μm to less than or equal to about 3 μm. In other variations, the solid-state argyrodite electrolyte represented by Li₆PS₅X, where X is selected from chloride (Cl), bromide (Br), iodine (I), or a combination thereof may coat or fill pores in the separator 26, and also, coat the solid-state electroactive material particles 50, 60 in then negative electrode 22 and/or positive electrode 24, so as to form a continuous electrolyte network, which may be a continuous lithium-ion conduction network.

In various aspects, the present disclosure provides a method for fabricating a solid-state argyrodite electrolyte for use in a solid-state battery, such as battery 20 illustrated in FIG. 1. For example, the present disclosure contemplates a method of making a solid-state argyrodite electrolyte, where the method generally includes concurrently or subsequently preparing a first suspension comprising Li₃PS₄ and a first solution comprising Li₂S and LiX, where X is selected from chloride (Cl), bromide (Br), iodine (I), or a combination thereof, and mixing the first suspension and the first solution to form a precursor admixture or liquid. The solid-state argyrodite electrolyte may be formed by removing the liquids or drying the precursor liquid.

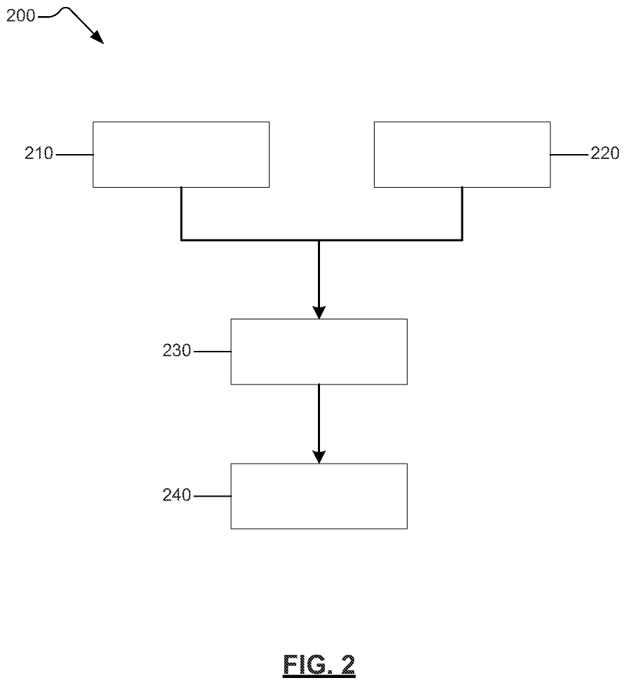

For example, FIG. 2 illustrates an exemplary method 200 for making a solid-state argyrodite electrolyte represented by Li₆PS₅X, where X is selected from chloride (Cl), bromide (Br), iodine (I), or a combination thereof. The method 200 may include contacting 230 a first suspension and a first solution.

The first suspension may be a suspension comprising Li₃PS₄ and an ester solvent. In the first suspension, the Li₃PS₄ is not necessarily solvated; rather the ester solvent may be used as a carrier or vehicle to suspend insoluble components, such as Li₃PS₄. The ester solvent may include one or more methyl esters (e.g., methyl formate, methyl acetate, methyl propionate, methyl butyrate, methyl pentanoate, and the like), ethyl esters (e.g., ethyl formate, ethyl acetate, ethyl propionate, ethyl butyrate, ethyl pentanoate, ethyl hexanoate, ethyl heptanoate, ethyl octanoate, ethyl decanoate, and the like), propyl esters (e.g., propyl acetate, propyl propanoate, isopropyl acetate, isopropyl palmitate, and the like), butyl esters (e.g., butyl acetate, butyl butyrate, isobutyl acetate, and the like), amyl esters (e.g., amyl acetate, pentyl propanoate, pentyl butyrate, pentyl pentanoate, pentyl hexanoate, isoamyl acetate, sec-amyl acetate, and the like), and any combination thereof.

The first solution may comprise Li₂S and LiX (where X is selected from chloride (Cl), bromide (Br), iodine (I), or a combination thereof) in an alcohol solvent. For example, the first solution may include greater than or equal to about 0.1 wt. % to less than or equal to about 20 wt. %, and in certain aspects, optionally about 6 wt. %, of Li₂S and LiX (where X is selected from chloride (Cl), bromide (Br), iodine (I), or a combination thereof) in the alcohol solvent. The alcohol solvent may include methanol, ethanol, propanol, isopropanol, butanol (e.g., 1-butanol, 2-butanol, isobutanol, tert-butanol), pentanol (e.g., 1-pentanol, 2-pentanol, 3-pentanol, isopentanol, neopentanol, cyclopentanol, and the like), and any combination thereof, including also straight chain, branched and cyclic isomers of other higher alcohols, such as hexanol, cyclohexanol, methylcyclohexanol, heptanol (e.g., 1-heptanol, 2-heptanol, 3-heptanol, 4-heptanol, iso-heptanol, and other isomers), nonanol, and the like.

In various aspects, contacting 230 the first suspension and the first solution may form a precursor mixture that includes the first suspension and first solution and mixing and stirring the precursor mixture to form a precursor liquid. For example, the first suspension and first solution may be mixed and stirred for a time greater than or equal to about 30 minutes to less than or equal to about 24 hours, and in certain aspects, optionally about 2 hours. The precursor mixture may have a 1:1:1 molar ratio of Li₃PS₄:Li₂S:LiX (where X is selected from chloride (Cl), bromide (Br), iodine (I), or a combination thereof).

In various aspects, the method 200 includes preparing 210 the first suspension. Preparing 210 the first suspension may include contacting Li₂S and P₂S₅ in the ester solvent to form a first mixture and mixing and stirring the first mixture for a time greater than or equal to about 8 hours to less than or equal to about 96 hours, and in certain aspects, optionally about 12 hours. A molar ratio of Li₂S and P₂S₅ in the first mixture may be greater than or equal to about 2.9 to less than or equal to about 3.1, and in certain aspects, optionally about 3.0. A total concentration of Li₂S and P₂S₅ in the first mixture may be greater than or equal to about 0.5 wt. % to less than or equal to about 50 wt. %, and in certain aspects, optionally about 10 wt. %. In one example, the first mixture may include initially, about 0.1984 g of Li₂S, about 0.3204 g of P₂S₅, and about 4.6671 g of ethyl propionate (EP).

In various aspects, the method 200 includes preparing 220 the first solution. Preparing 220 the first solution may include contacting Li₂S and LiX (where X is selected from chloride (Cl), bromide (Br), iodine (I), or a combination thereof) in the alcohol solvent to form a second mixture and mixing and stirring the second mixture for a time greater than or equal to about 0.1 hours to less than or equal to about 24 hours, and in certain aspects, optionally about 0.5 hours. A molar ratio of Li₂S and LiX (where X is selected from chloride (Cl), bromide (Br), iodine (I) of combination thereof) in the second mixture may be greater than or equal to about 0.9 to less than or equal to about 1.1, and in certain aspects, optionally about 1.0. A total concentration of Li₂S and LiX (where X is selected from chloride (Cl), bromide (Br), iodine (I), or a combination thereof) in the second mixture may be greater than or equal to about 0.1 wt. % to less than or equal to about 20 wt. %, and in certain aspects, optionally about 6 wt. %. In one example, the second mixture may include initially about 0.1346 g Li₂S, about 0.2519 g LiBr, and about 5.9980 g ethanol.

In various aspects, the method 200 includes removing 240 the solvents (e.g., ester and alcohol co-solvents) from the precursor liquid to form the solid-state argyrodite electrolyte represented by Li₆PS₅X (where X is selected from chloride (Cl), bromide (Br), iodine (I), or a combination thereof). Removing 240 the solvents may include drying the precursor liquid to remove liquids, for example, under negative pressure via vacuum-drying, for example, at a temperature greater than or equal to about 80° C. to less than or equal to about 700° C., optionally greater than or equal to about 80° C. to less than or equal to about 550° C., optionally greater than or equal to about 80° C. to less than or equal to about 200° C., and in certain aspects, optionally about 90° C., for a period greater than or equal to about 30 minutes to less than or equal to about 48 hours, and in certain aspects, optionally about 3 hours. The solid-state argyrodite electrolyte represented by Li₆PS₅X, where X is selected from chloride (Cl), bromide (Br), iodine (I), or a combination thereof, may include a plurality of particles having an average particle size greater than or equal to about 0.1 μm to less than or equal to about 100 μm, and in certain aspects, optionally greater than or equal to about 1 μm to less than or equal to about 3 μm. The solid-state argyrodite electrolyte Li₆PS₅X, where X is selected from chloride (Cl), bromide (Br), iodine (I), or a combination thereof, may have an ionic conductivity greater than or equal to about 1.0×10⁻⁴ S/cm to less than or equal to about 10×10⁻³ S/cm, and in certain aspects, optionally about 1.4×10⁻⁴ S/cm, at about 25° C.

In various aspects, the present disclosure provides a method for fabricating a battery, including a solid-state argyrodite electrolyte represented by Li₆PS₅X (where X is selected from chloride (Cl), bromide (Br), iodine (I), or a combination thereof). For example, the present disclosure contemplates a method of making an electrode, where the method generally includes contacting a precursor liquid with an electrode precursor in the form of an electroactive material layer. The method may further include drying the precursor liquid to form the solid-state argyrodite electrolyte represented by Li₆PS₅X (where X is selected from chloride (Cl), bromide (Br), iodine (I), or a combination thereof), where the precursor liquid is prepared by a mixture of a first suspension comprising Li₃PS₄ and a first solution comprising Li₂S and LiX (where X is selected from chloride (Cl), bromide (Br), iodine (I), or a combination thereof). Notably, the skilled artisan will recognize that Li₆PS₅X results from the combination of Li₃PS₄+Li₂S+LiX.

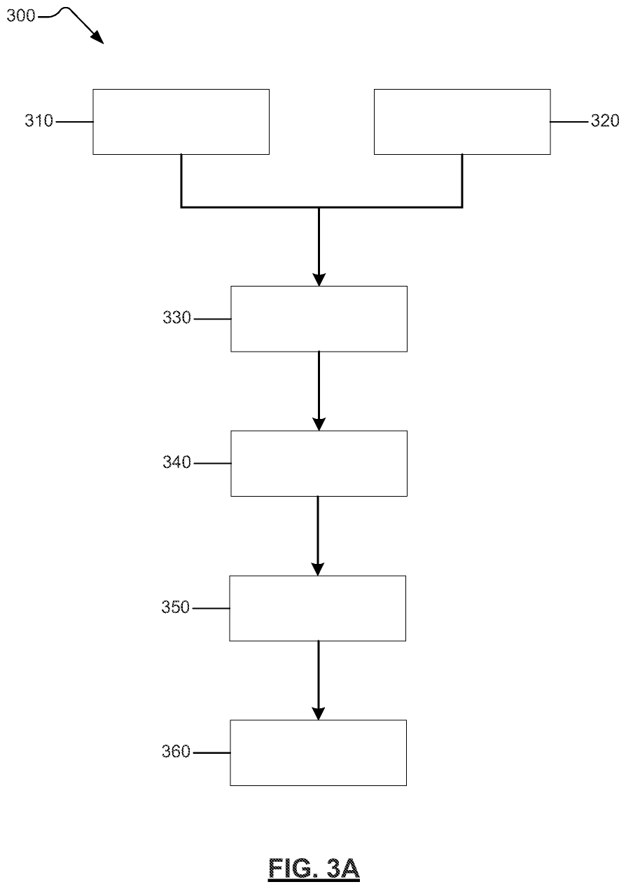

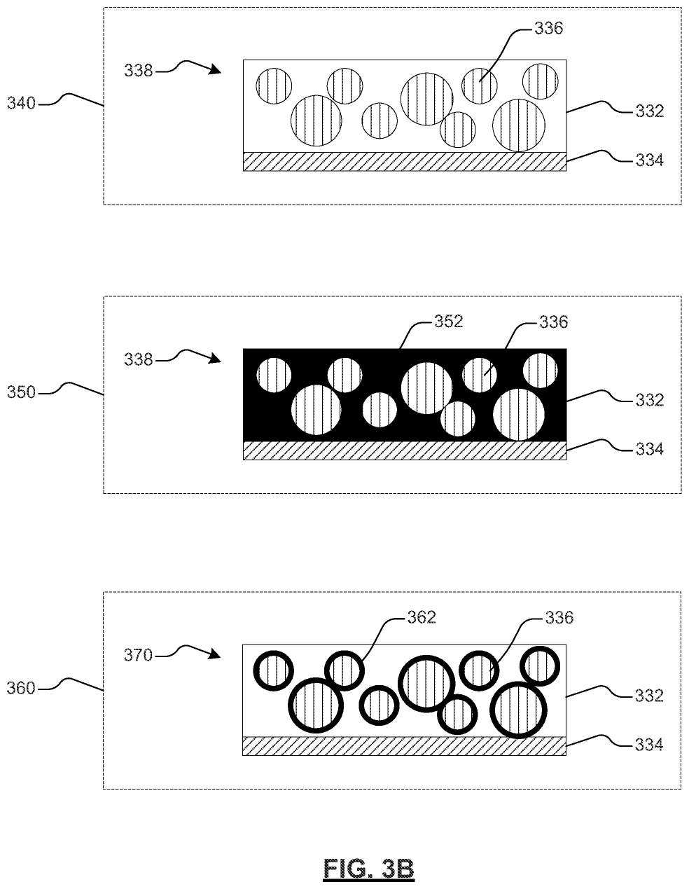

For example, FIGS. 3A and 3B, illustrate an exemplary method 300 for making an electrode 370 that includes a solid-state argyrodite electrolyte 362 represented by Li₆PS₅X (where X is selected from chloride (Cl), bromide (Br), iodine (I), or a combination thereof). The method 300 may include contacting 350 a precursor liquid 352 and an electroactive material layer 332 of a precursor or pristine electrode 338, for example only, using a drop-wise, a spraying, or a soaking process. In certain variations, contacting 350 the precursor liquid 352 and the electroactive material layer 332 of the precursor electrode 338 may include impregnating the precursor electrode 338 with the precursor liquid 352. In each instance, the precursor liquid 352 may include a 1:1:1 molar ratio of Li₃PS₄:Li₂S:LiX (where X is selected from chloride (Cl), bromide (Br), iodine (I), or a combinations thereof) dispersed in a co-solvent system that includes an ester solvent and an alcohol solvent, such as detailed above.

In various aspects, the method includes preparing 340 the precursor electrode 338. As illustrated in FIG. 3B, the precursor electrode 338 includes an electroactive material layer 332 disposed on or adjacent to a surface of a current collector 334. The electroactive material layer 332 may include a plurality of solid-state electroactive material particles 336. Preparing 340 the precursor electrode 338 may include disposing the plurality of solid-state electroactive material particles 336 along the surface of the current collector 334 to form the electroactive material layer 332.

In various aspects, the method includes preparing 330 the precursor liquid 352. Preparing 330 the precursor liquid 352 may include contacting a first suspension and a first solution. The first suspension may be a Li₃PS₄ suspension including the ester solvent. The first solution may be a Li₂S and LiX (where X is selected from chloride (Cl), bromide (Br), iodine (I), or a combination thereof) suspension including the alcohol solvent. For example, the first solution may include greater than or equal to about 0.1 wt. % to less than or equal to about 20 wt. %, and in certain aspects, optionally about 6 wt. %, of Li₂S and LiX (where X is selected from chloride (Cl), bromide (Br), iodine (I), or a combination thereof) in the alcohol solvent.

In various aspects, contacting the first suspension and the first solution to form 330 the precursor liquid 352 may include mixing and stirring a mixture of the first suspension and the first solution. For example, the first suspension and first solution may be mixed and stirred for a time greater than or equal to about 30 minutes to less than or equal to about 24 hours, and in certain aspects, optionally about 2 hours.

In various aspects, the method 300 includes preparing 310 the first suspension. Preparing 310 the first suspension may include contacting Li₂S and P₂S₅ in the ester solvent to form a first mixture and mixing and stirring the first mixture for a time greater than or equal to about 8 hours to less than or equal to about 96 hours, and in certain aspects, optionally about 12 hours. A molar ratio of Li₂S and P₂S₅ in the first mixture may be greater than or equal to about 2.9 to less than or equal to about 3.1, and in certain aspects, optionally about 3.0. A total concentration of Li₂S and P₂S₅ in the first mixture may be greater than or equal to about 0.5 wt. % to less than or equal to about 50 wt. %, and in certain aspects, optionally about 10 wt. %. In one example, the first mixture may include initially, about 0.1984 g of Li₂S, about 0.3204 g of P₂S₅, and about 4.6671 g of ethyl propionate (EP).

In various aspects, the method 300 includes preparing 320 the first solution. Preparing 320 the first solution may include contacting Li₂S and LiX (where X is selected from chloride (Cl), bromide (Br), iodine (I), or a combination thereof) in the alcohol solvent to form a second mixture and mixing and stirring the second mixture for a time greater than or equal to about 0.1 hours to less than or equal to about 24 hours, and in certain aspects, optionally about 0.5 hours. A molar ratio of Li₂S and LiX (where X is selected from chloride (Cl), bromide (Br), iodine (I), or a combination thereof) in the second mixture may be greater than or equal to about 0.9 to less than or equal to about 1.1, and in certain aspects, optionally about 1.0. A total concentration of Li₂S and LiX (where X is selected from chloride (Cl), bromide (Br), iodine (I), or a combination thereof) in the second mixture may be greater than or equal to about 0.1 wt. % to less than or equal to about 20 wt. %, and in certain aspects, optionally about 6 wt. %. In one example, the second mixture may include initially about 0.1346 g Li₂S, about 0.2519 g LiBr, and about 5.9980 g ethanol.

In various aspects, the method 300 includes removing 360 the solvents (e.g., ester and alcohol co-solvents) from the precursor liquid 352 to form the solid-state argyrodite Li₆PS₅X (where X is selected from chloride (Cl), bromide (Br), iodine (I), or a combination thereof) electrolyte 362. Removing 360 the solvents may include drying the precursor liquid optionally under negative pressures. For example, the method may include vacuum-drying the precursor liquid, for example, at a temperature greater than or equal to about 80° C. to less than or equal to about 700° C., optionally greater than or equal to about 80° C. to less than or equal to about 550° C., optionally greater than or equal to about 80° C. to less than or equal to about 200° C., and in certain aspects, optionally about 90° C., for a period greater than or equal to about 30 minutes to less than or equal to about 48 hours, and in certain aspects, optionally about 3 hours.

As illustrated in FIG. 3B, the solid-state argyrodite electrolyte 362 represented by Li₆PS₅X (where X is selected from chloride (Cl), bromide (Br), iodine (I), or a combination thereof) may form a continuous coating on the solid-state electroactive material particles 336. For example, during evaporation, the solid-state electroactive material particles 336 may act as a crystal nucleus providing a growth side for the formation of the solid-state argyrodite. The coating may have a thickness greater than or equal to about 0.01 μm to less than or equal to about 5 μm. The electrode 370 may include greater than or equal to about 5 wt. % to less than or equal to about 50 wt. %, and in certain aspects, optionally about 20 wt. %, of the solid-state argyrodite Li₆PS₅X (where X is selected from chloride (Cl), bromide (Br), iodine (I), or a combinations thereof) electrolyte 362. The solid-state argyrodite Li₆PS₅X (where X is selected from chloride (Cl), bromide (Br), iodine (I), or a combinations thereof) electrolyte 362 may have an ionic conductivity greater than or equal to about 1.0×10⁻⁴ S/cm to less than or equal to about 10×10⁻³ S/cm, and in certain aspects, optionally about 1.4×10⁻⁴ S/cm, at about 25° C.

In various aspects, the present disclosure provides a method for fabricating a solid-state battery including a solid-state argyrodite electrolyte Li₆PS₅X (where X is selected from chloride (Cl), bromide (Br), iodine (I), or a combinations thereof), such as the battery 20 illustrated in FIG. 1. For example, the present disclosure contemplates a method of making a solid-state battery, where the method generally includes contacting a precursor liquid and a precursor battery or battery cell core and drying the precursor liquid to form the solid-state argyrodite Li₆PS₅X (where X is selected from chloride (Cl), bromide (Br), iodine (I), or a combinations thereof) electrolyte, where the precursor liquid comprises a mixture of a first suspension comprising Li₃PS₄ and a first solution comprising Li₂S and LiX (where X is selected from chloride (Cl), bromide (Br), iodine (I), or a combinations thereof).

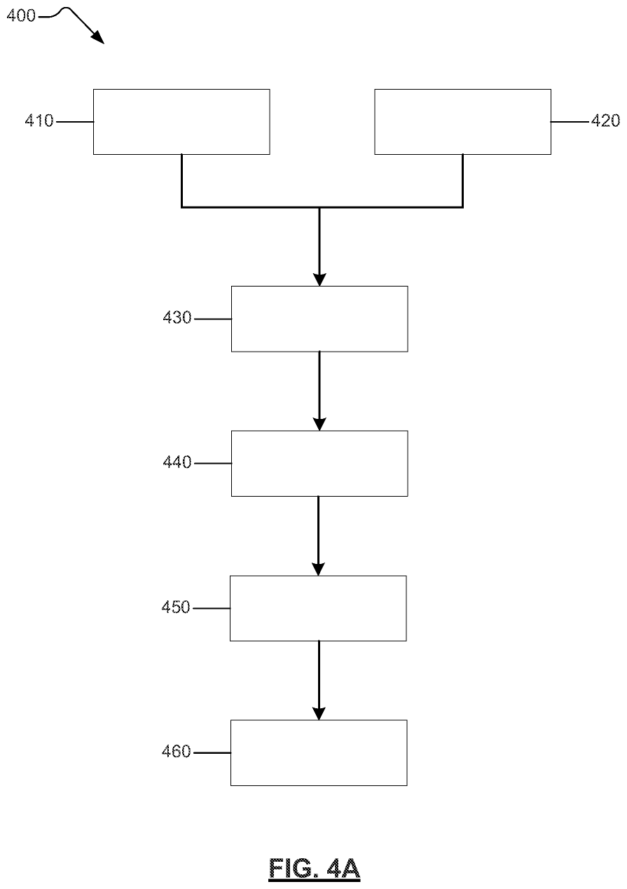

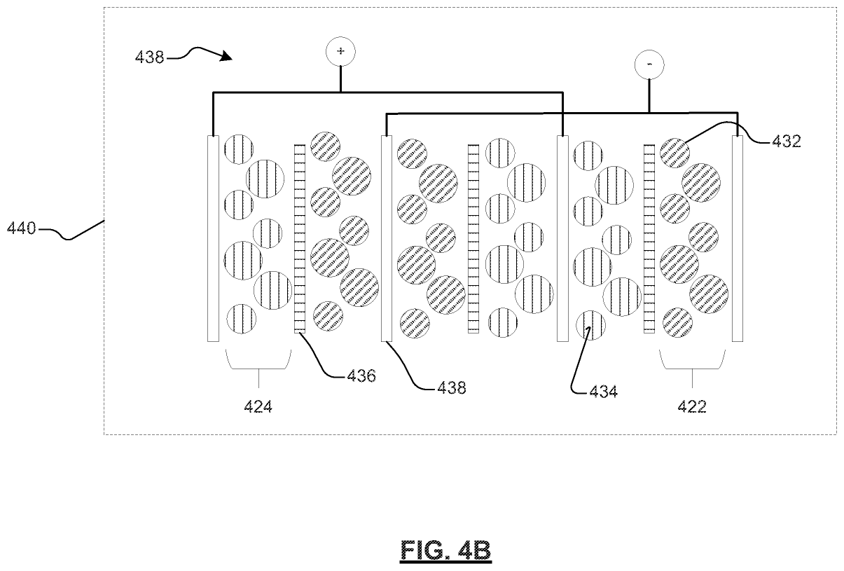

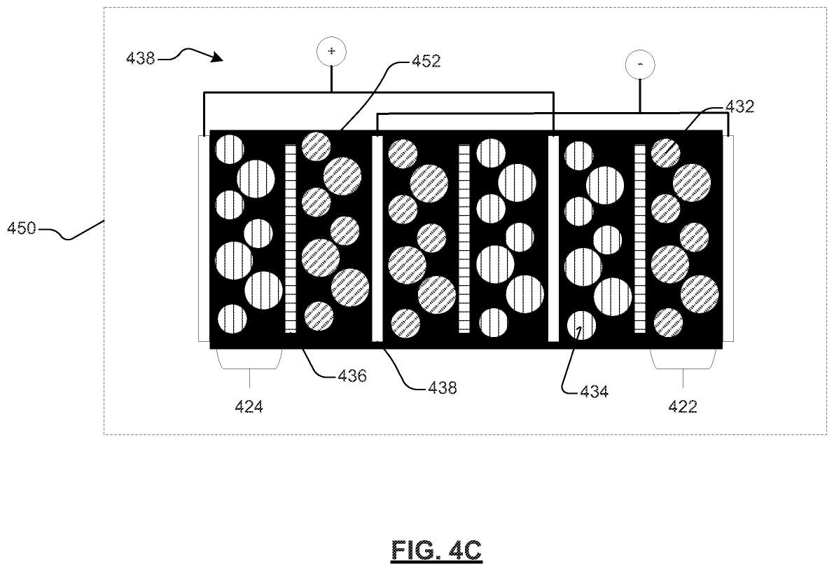

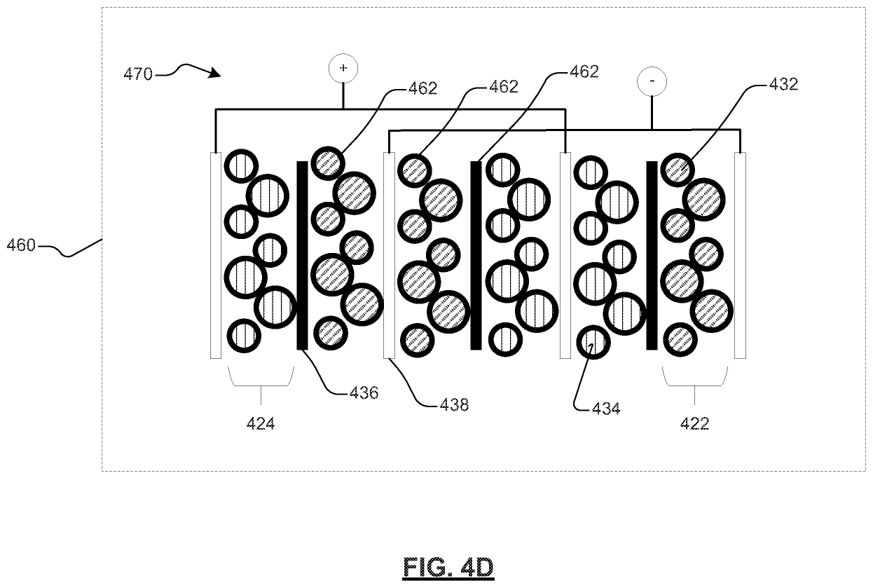

For example, FIGS. 4A-4D, illustrate an exemplary method 400 for making a battery 470 that includes a solid-state argyrodite electrolyte 462 represented by Li₆PS₅X (where X is selected from chloride (Cl), bromide (Br), iodine (I), or a combination thereof). The method 400 may include contacting 450 a precursor liquid 452 and a battery core cell 438. For example, the precursor liquid 452 may be injected into the battery cell core 438. In certain variations, contacting 450 the precursor liquid 452 and the battery cell core 438 may include impregnating the battery cell core 438 with the precursor liquid 452. In each instance, the precursor liquid 452 may include a 1:1:1 molar ratio of Li₃PS₄:Li₂S:LiX (where X is selected from chloride (Cl), bromide (Br), iodine (I), or a combination thereof) suspended in a co-solvent system that includes an ester solvent and an alcohol solvent.

The ester solvent may include one more methyl esters (e.g., methyl formate, methyl acetate, methyl propionate, methyl butyrate, methyl pentanoate, and the like), ethyl esters (e.g., ethyl formate, ethyl acetate, ethyl propionate, ethyl butyrate, ethyl pentanoate, ethyl hexanoate, ethyl heptanoate, ethyl octanoate, ethyl decanoate, and the like), propyl esters (e.g., propyl acetate, propyl propanoate, isopropyl acetate, isopropyl palmitate, and the like), butyl esters (e.g., butyl acetate, butyl butyrate, isobutyl acetate, and the like), amyl esters (e.g., amyl acetate, pentyl propanoate, pentyl butyrate, pentyl pentanoate, pentyl hexanoate, isoamyl acetate, sec-amyl acetate, and the like), and any combination thereof.

The alcohol solvent may include methanol, ethanol, propanol, isopropanol, butanol (e.g., 1-butanol, 2-butanol, isobutanol, tert-butanol), pentanol (e.g., 1-pentanol, 2-pentanol, 3-pentanol, isopentanol, neopentanol, cyclopentanol, and the like), and any combination thereof, including also straight chain, branched and cyclic isomers of other higher alcohols, such as hexanol, cyclohexanol, methylcyclohexanol, heptanol (e.g., 1-heptanol, 2-heptanol, 3-heptanol, 4-heptanol, iso-heptanol, and other isomers), nonanol, and the like.

In various aspects, the method includes preparing 440 the battery cell core 438. As illustrated in FIG. 4B, the battery cell core 438 includes one or more positive electrodes 424, like positive electrode 24 illustrated in FIG. 1, including a plurality of positive solid-state electroactive particles 434, and one or more negative electrodes 422, like negative electrode 22 illustrated in FIG. 1, including a plurality of negative solid-state electroactive particles 432. A separator 436, like separator 26 illustrated in FIG. 1, is disposed between the positive and negative electrodes 424, 422. Preparing 440 the precursor battery 438 may include sequentially disposing the plurality of solid-state electroactive material particles 432, 434, current collectors 438, and separators 436.

In various aspects, the method includes preparing 430 the precursor liquid 452. Preparing 430 the precursor liquid 452 may include contacting a first suspension and a first solution. The first suspension may be a Li₃PS₄ suspension including the ester solvent. The first solution may be a Li₂S and LiX (where X is selected from chloride (Cl), bromide (Br), iodine (I), or a combinations thereof) solution including the alcohol solvent. For example, the first solution may include greater than or equal to about 0.1 wt. % to less than or equal to about 20 wt. %, and in certain aspects, optionally about 6 wt. %, of Li₂S and LiX (where X is selected from chloride (Cl), bromide (Br), iodine (I), or a combination thereof) in the alcohol solvent.

In various aspects, contacting the first suspension and the first solution to form 430 the precursor liquid 452 may include mixing and stirring a mixture of the first suspension and the first solution. For example, the first suspension and the first solution may be mixed and stirred for a time greater than or equal to about 30 minutes to less than or equal to about 24 hours, and in certain aspects, optionally about 2 hours.

In various aspects, the method 400 includes preparing 410 the first suspension. Preparing 410 the first suspension may include contacting Li₂S and P₂S₅ in the ester solvent to form a first mixture and mixing and stirring the first mixture for a time greater than or equal to about 8 hours to less than or equal to about 96 hours, and in certain aspects, optionally about 12 hours. A molar ratio of Li₂S and P₂S₅ in the first mixture may be greater than or equal to about 2.9 to less than or equal to about 3.1, and in certain aspects, optionally about 3.0. A total concentration of Li₂S and P₂S₅ in the first mixture may be greater than or equal to about 0.5 wt. % to less than or equal to about 50 wt. %, and in certain aspects, optionally about 10 wt. %. In one example, the first mixture may include initially, about 0.1984 g of Li₂S, about 0.3204 g of P₂S₅, and about 4.6671 g of ethyl propionate (EP).

In various aspects, the method 400 includes preparing 420 the first solution. Preparing 420 the first solution may include contacting Li₂S and LiX (where X is selected from chloride (Cl), bromide (Br), iodine (I), or a combination thereof) in the alcohol solvent to form a second mixture and mixing and stirring the second mixture for a time greater than or equal to about 0.1 hours to less than or equal to about 24 hours, and in certain aspects, optionally about 0.5 hours. A molar ratio of Li₂S and LiX (where X is selected from chloride (Cl), bromide (Br), iodine (I), or a combination thereof) in the second mixture may be greater than or equal to about 0.9 to less than or equal to about 1.1, and in certain aspects, optionally about 1.0. A total concentration of Li₂S and LiX (where X is selected from chloride (Cl), bromide (Br), iodine (I), or a combination thereof) in the second mixture may be greater than or equal to about 0.1 wt. % to less than or equal to about 20 wt. %, and in certain aspects, optionally about 6 wt. %. In one example, the second mixture may include initially about 0.1346 g Li₂S, about 0.2519 g LiBr, and about 5.9980 g ethanol.

In various aspects, the method 400 includes removing 460 the solvents (e.g., ester and alcohol co-solvents) from the precursor liquid 452 to form the solid-state argyrodite Li₆PS₅X (where X is selected from chloride (Cl), bromide (Br), iodine (I), or a combination thereof) electrolyte 462. Removing 460 the solvents may include vacuum-drying the precursor liquid, for example, at a temperature greater than or equal to about 80° C. to less than or equal to about 300° C. for a period greater than or equal to about 30 minutes to less than or equal to about 48 hours, and in certain aspects, optionally about 3 hours. This low temperature process will ensure stability of the polymer components of the electrodes 422, 424 and separator 436.

As illustrated in FIG. 4D, the solid-state argyrodite electrolyte 462 represented by Li₆PS₅X (where X is selected from chloride (Cl), bromide (Br), iodine (I), or a combination thereof) may form a continuous coating on the solid-state electroactive material particles 432, 434. The solid-state argyrodite Li₆PS₅X (where X is selected from chloride (Cl), bromide (Br), iodine (I), a combination thereof) electrolyte 462 may also fill or coat pores in the separators 436. The coating may have a thickness greater than or equal to about 0.01 μm to less than or equal to about 5 μm. The electrode 470 may include greater than or equal to about 5 wt. % to less than or equal to about 50 wt. %, and in certain aspects, optionally about 20 wt. %, of the solid-state argyrodite electrolyte 462 represented by Li₆PS₅X (where X is selected from chloride (Cl), bromide (Br), iodine (I), or a combination thereof). The solid-state argyrodite electrolyte 462 represented by Li₆PS₅X (where X is selected from chloride (Cl), bromide (Br), iodine (I), or a combination thereof) may have an ionic conductivity greater than or equal to about 1.0×10⁻⁴ S/cm to less than or equal to about 10×10⁻³ S/cm, and in certain aspects, optionally about 1.4×10⁻⁴ S/cm at about 25° C.

The combination of ester solvent and alcohol solvent for use during the formation of a solid-state argyrodite electrolyte represented by Li₆PS₅X (where X is selected from chloride (Cl), bromide (Br), iodine (I), or a combination thereof), such as the solid-state argyrodite electrolyte 30 represented by Li₆PS₅X (where X is selected from chloride (Cl), bromide (Br), iodine (I), or a combination thereof) illustrated in FIG. 1, the solid-state argyrodite electrolyte 362 represented by Li₆PS₅X (where X is selected from chloride (Cl), bromide (Br), iodine (I), or a combination thereof) illustrated in FIG. 3, and/or the solid-state argyrodite electrolyte 462 represented by Li₆PS₅X (where X is selected from chloride (Cl), bromide (Br), iodine (I), or a combination thereof) illustrated in FIG. 4, may provide certain benefits. For example, as illustrated in TABLE 1, a co-solvent system including an ester solvent and an alcohol solvent, as compared to a co-solvent system including a cyclic ether solvent (e.g., tetrahydrofuran) and an alcohol solvent and/or a co-solvent system including a nitrile solvent (e.g., acetonitrile) and an alcohol solvent, may have both improved ionic resistance and purity.

| Samples | Control Group 1 | Control Group 2 | Experiment |
|---|---|---|---|
| Solvents for Li₂S | Cyclic Ether (e.g., | Nitrile (e.g., | Ester (e.g. ethyl |
| and P₂S₅ | tetrahydrofuran) | acetonitrile) | propionate) |
| Solvents for Li₂S | Alcohol (e.g., | Alcohol (e.g., | Alcohol (e.g., |
| and LiBr | ethanol) | ethanol) | ethanol) |
| Drying Conditions | 90° C./3 Hrs | 90° C./3 Hrs | 90° C./3 Hrs |
| Ionic Resistance | ~1033 Ω | ~577 Ω | ~726 Ω |
| (EIS Data at | | | |
| 25° C.) | | | |
| Particle Size | 2~5 μm | 1~3 μm | l~3 μm |
| Purity | High | Low | High |

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for making a solid-state argyrodite electrolyte, the method comprising:
contacting a first suspension and a first solution to form a precursor, wherein the first suspension comprises Li₃PS₄ and an ester solvent, and the first solution comprises Li₂S, LiX (where X is selected from chloride (Cl), bromide (Br), iodine (I), or a combination thereof), and an alcohol solvent; and
removing the ester solvent and the alcohol solvent from the precursor to form the solid-state argyrodite electrolyte represented by the formula Li₆PS₅X, where X is selected from chloride (Cl), bromide (Br), iodine (I), or any combination thereof and the solid-state argyrodite electrolyte has an ionic conductivity greater than or equal to about 1.0×10⁻⁴ S/cm to less than or equal to about 10×10⁻³ S/cm at about 25° C.

2. The method of claim 1, wherein the ester solvent is selected from the group consisting of: methyl formate, methyl acetate, methyl propionate, methyl butyrate, methyl pentanoate, ethyl formate, ethyl acetate, ethyl propionate, ethyl butyrate, ethyl pentanoate, ethyl hexanoate, ethyl heptanoate, ethyl octanoate, ethyl decanoate, propyl acetate, propyl propanoate, isopropyl acetate, isopropyl palmitate, butyl acetate, butyl butyrate, isobutyl acetate, amyl acetate, pentyl propanoate, pentyl butyrate, pentyl pentanoate, pentyl hexanoate, isoamyl acetate, sec-amyl acetate, and combinations thereof, and
wherein the alcohol solvent is selected from the group consisting of: 1-butanol, 2-butanol, isobutanol, tert-butanol, 1-pentanol, 2-pentanol, 3-pentanol, isopentanol, neopentanol, cyclopentanol, hexanol, cyclohexanol, methylcyclohexanol, heptanol, nonanol, and combinations thereof.

3. The method of claim 1, wherein contacting the first suspension and the first solution to form a precursor comprises forming a mixture comprising the first suspension and the first solution and mixing and stirring the mixture.

4. The method of claim 3, wherein the mixture is mixed and stirred for a time greater than or equal to about 30 minutes to less than or equal to about 24 hours.

5. The method of claim 1, wherein the precursor has a 1:1:1 molar ratio of Li₃PS₄:Li₂S:LiX.

6. The method of claim 1, wherein the method further comprises preparing the first suspension, wherein preparing the first suspension comprises:
contacting Li₂S and P₂S₅ in the ester solvent to form a mixture; and
mixing and stirring the mixture for a time greater than or equal to about 8 hours to less than or equal to about 96 hours.

7. The method of claim 6, wherein the mixture has a molar ratio of the Li₂S and P₂S₅ greater than or equal to about 2.9 to less than or equal to about 3.1 and a total concentration of the Li₂S and the P₂S₅ in the mixture is greater than or equal to about 0.5 wt. % to less than or equal to about 50 wt. %.

8. The method of claim 1, wherein the method further comprises preparing the first solution, wherein preparing the first solution comprises:
contacting Li₂S and LiX in the alcohol solvent to form a mixture; and
mixing and stirring the mixture for a time greater than or equal to about 0.1 hours to less than or equal to about 24 hours.

9. The method of claim 8, wherein the mixture has a molar ratio of the Li₂S and the LiX of greater than or equal to about 0.9 to less than or equal to about 1.1, and a total concentration of the Li₂S and the LiX in the mixture is greater than or equal to about 0.1 wt. % to less than or equal to about 20 wt. %.

10. The method of claim 1, wherein the removing the ester solvent and the alcohol solvent from the precursor solution to form the solid-state argyrodite electrolyte further comprises:
heating the precursor to a temperature greater than or equal to about 80° C. to less than or equal to about 700° C. for a time greater than or equal to about 30 minutes to less than or equal to about 48 hours.

11. The method of claim 1, wherein the solid-state argyrodite electrolyte comprises a plurality of Li₆PS₅X particles having an average particle size greater than or equal to about 0.1 μm to less than or equal to about 100 μm.

12. A method for making an electrode comprising a solid-state argyrodite electrolyte, the method comprising:
contacting a precursor liquid and a precursor electrode, wherein the precursor liquid comprises a 1:1:1 molar ratio of Li₃PS₄:Li₂S:LiX, where X is selected from chloride (Cl), bromide (Br), iodine (I), or any combination thereof suspended in a co-solvent system that comprises an ester solvent and an alcohol solvent; and
removing the co-solvent system comprising the ester solvent and the alcohol solvent from the precursor liquid to form the electrode comprising the solid-state argyrodite electrolyte represented by the formula Li₆PS₅X, where X is selected from chloride (Cl), bromide (Br), iodine (I), or any combination thereof, and the solid-state argyrodite electrolyte has an ionic conductivity greater than or equal to about 1.0×10⁻⁴ S/cm to less than or equal to about 10×10⁻³ S/cm at about 25° C.

13. The method of claim 12, wherein the method further comprises preparing the precursor liquid, wherein preparing the precursor liquid comprises:
contacting a first suspension and a first solution, wherein the first suspension comprises Li₃PS₄ and an ester solvent and the first solution comprises the Li₂S, the LiX, and the alcohol solvent.

14. The method of claim 13, wherein contacting the first suspension and the first solution to form a precursor liquid comprises forming a first mixture comprising the first suspension and the first solution and mixing and stirring the first mixture for a time greater than or equal to about 30 minutes to less than or equal to about 24 hours.

15. The method of claim 13, wherein the method further comprises preparing the first suspension, wherein preparing the first suspension comprises:
contacting Li₂S and P₂S₅ in the ester solvent to form a second mixture; and
mixing and stirring the second mixture for a time greater than or equal to about 8 hours to less than or equal to about 96 hours.

16. The method of claim 13, wherein the method further comprises preparing the first solution, wherein preparing the first solution comprises:
contacting the Li₂S and the LiX in the alcohol solvent to form a third mixture; and
mixing and stirring the third mixture for a time greater than or equal to about 0.1 hours to less than or equal to about 24 hours.

17. The method of claim 12, wherein removing the ester solvent and the alcohol solvent from the precursor liquid further comprises:
heating the precursor liquid to a temperature of greater than or equal to about 80° C. to less than or equal to about 700° C. for a time of greater than or equal to about 30 minutes to less than or equal to about 48 hours.

18. The method of claim 12, wherein the electrode comprises a plurality of solid-state electroactive material particles and the solid-state argyrodite electrolyte that forms a continuous coating on the solid-state electroactive material particles.

19. A method for making an electrochemical cell comprising a solid-state argyrodite electrolyte, the method comprising:
contacting a precursor liquid and at least a portion of a precursor cell, wherein the precursor liquid comprises a 1:1:1 molar ratio of Li₃PS₄:Li₂S:LiX, where X is selected from chloride (Cl), bromide (Br), iodine (I), or any combination thereof suspended in a co-solvent system that comprises an ester solvent and an alcohol solvent; and
removing the co-solvent system comprising the ester solvent and the alcohol solvent from the precursor liquid to form the electrochemical cell comprising the solid-state argyrodite electrolyte represented by the formula Li₆PS₅X, where X is selected from chloride (Cl), bromide (Br), iodine (I), or any combination thereof, and the solid-state argyrodite electrolyte has an ionic conductivity greater than or equal to about 1.0×10⁻⁴ S/cm to less than or equal to about 10×10⁻³ S/cm at about 25° C.

20. The method of claim 19, wherein the method further comprises preparing the precursor liquid, wherein preparing the precursor liquid comprises:
preparing a first suspension, wherein preparing the first suspension comprises:
contacting Li₂S and P₂S₅ in the ester solvent to form a second mixture, and
mixing and stirring the second mixture for a time greater than or equal to about 8 hours to less than or equal to about 96 hours;
preparing the first solution, wherein preparing the first solution comprises:
contacting the Li₂S and the LiX in the alcohol solvent to form a third mixture, and
mixing and stirring the third mixture for a time greater than or equal to about 0.1 hours to less than or equal to about 24 hours; and
contacting the first suspension and the first solution.
